(19) United States
(12) Patent Application Publication
(10) Pub. No.: US 2009/0286636 A1
(43) Pub. Date: Nov. 19, 2009

(54) Sealed tensioner

(76) Inventors: Alexander SERKH, Troy, MI (US); Peter Alan WARD, Farmington Hills, MI (US)

Correspondence Address: THE GATES CORPORATION, IP LAW DEPT. 10-A3, 1551 WEWATTA STREET, DENVER, CO, 80202, US

(21) Appl. No.: 12/152,151

(22) Filed: May 13, 2008

(51) Int. Cl. F16H 7/12

(52) U.S. Cl. 474/135

(57) ABSTRACT

A sealed tensioner comprising a base, an arm pivotally engaged with the base, a spring engaged with the base and the arm, a bushing operationally disposed between the base and the arm, the arm being pivotally engaged with the bushing, a first seal engaged with the arm for preventing a fluid from contacting the bushing, and a second seal engaged with the base for preventing a fluid from contacting the bushing.

### FIELD OF THE INVENTION

The invention relates to a sealed tensioner, and more particularly, a sealed tensioner having seals for preventing a fluid from contacting a bushing.

### BACKGROUND OF THE INVENTION

The two most common means for synchronously driving internal combustion engine rotating members, such as cam shafts and balance shafts from a crankshaft are timing chains and belts. Timing chains require engine oil to operate. In comparison most timing belt applications require that no oil be present in the belt drive as the presence of oil can damage the belt and inhibit its intended purpose. Recent improvements in belts no long require that a belt be sealed from the engine oil environment.

The recent improvement of belts to operate in oil, however poses other problems that need to be solved. One specific problem is properly tensioning the belt drive to keep the camshaft synchronized with the crankshaft. Should the camshaft or other synchronized driven crankshaft component no longer be properly synchronized with the crankshaft catastrophic engine damage can result.

To transmit power through the belt from a rotating engine crankshaft, one side of the belt is pulled around the crankshaft and is commonly referred to as the belt tight side. Conversely, the other side is referred to as the belt slack side, since the belt is being pushed away from the crankshaft. It is necessary to provide tensioning to the slack side of the belt to prevent the belt from becoming unduly slack and thus causing a loss of synchronization between the crankshaft and the components rotated by the crankshaft. This loss of synchronization is commonly referred to as “tooth jump” or “ratcheting”.

Compounding the problem of eliminating belt slack to prevent “tooth jump” or “ratcheting” is excessive tensioner arm motion or vibration induced by the engine's angular vibration. Excessive tensioner arm motion can not only cause “tooth jump” or “ratcheting”, but can also reduce the useful life of the tensioner and the belt as well. To minimize the amount of tensioner arm vibration friction damping is commonly used to prevent excessive tensioner arm movement.

However, in prior art tensioners the presence of oil makes friction damping impractical because the components are used to create friction. The presence of oil defeats this purpose. Prior art regarding the use of belts in oil, such as disclosed in WO 2007/036959 A1 and WO 2007/036960 A1 by Di Meco, use a guide or shoe biased by a spring to tension a belt. They do not provide a method or mechanism for damping that is used for belts in non-oil bath applications.

Other tensioners are known which comprise features for addressing the problem of preventing foreign particulate debris from contacting a bushing. However, these are not sealed against fluid intrusion.

Representative of the art is U.S. Pat. No. 5,964,674 (1999) which discloses a belt tensioner of the Zed type with a base member, a pivot-arm, a pivot-pin, a pulley attached to the pivot-arm, a torsional spring attached between the base member and pivot-arm, and wherein the base member has a “tube pan” shape with a cantilevered inner wall that supports the pivot-pin, a cantilevered outer wall, and a bottom wall interconnecting the inner and outer walls and oriented with the bottom wall juxtaposed the pivot-arm. Optionally, the spring is connected to a damping mechanism that generates a reaction force in generally the same direction as a belt force or hub load. In another embodiment, a second, damping spring generates a reaction force in generally the same direction as the belt force with a constant damping force.

What is needed is a sealed tensioner having seals for preventing a fluid from contacting a bushing. The present invention meets this need.

### SUMMARY OF THE INVENTION

The primary aspect of the invention is to provide a sealed tensioner having seals for preventing a fluid from contacting a bushing.

Other aspects of the invention will be pointed out or made obvious by the following description of the invention and the accompanying drawings.

The invention comprises a sealed tensioner comprising a base, an arm pivotally engaged with the base, a spring engaged with the base and the arm, a bushing operationally disposed between the base and the arm, the arm being pivotally engaged with the bushing, a first seal engaged with the arm for preventing a fluid from contacting the bushing, and a second seal engaged with the base for preventing a fluid from contacting the bushing.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is an exploded view of the tensioner.

FIG. 2 is a cross-sectional view of the tensioner.

### DETAILED DESCRIPTION OF THE PREFERRED EMBODIMENT

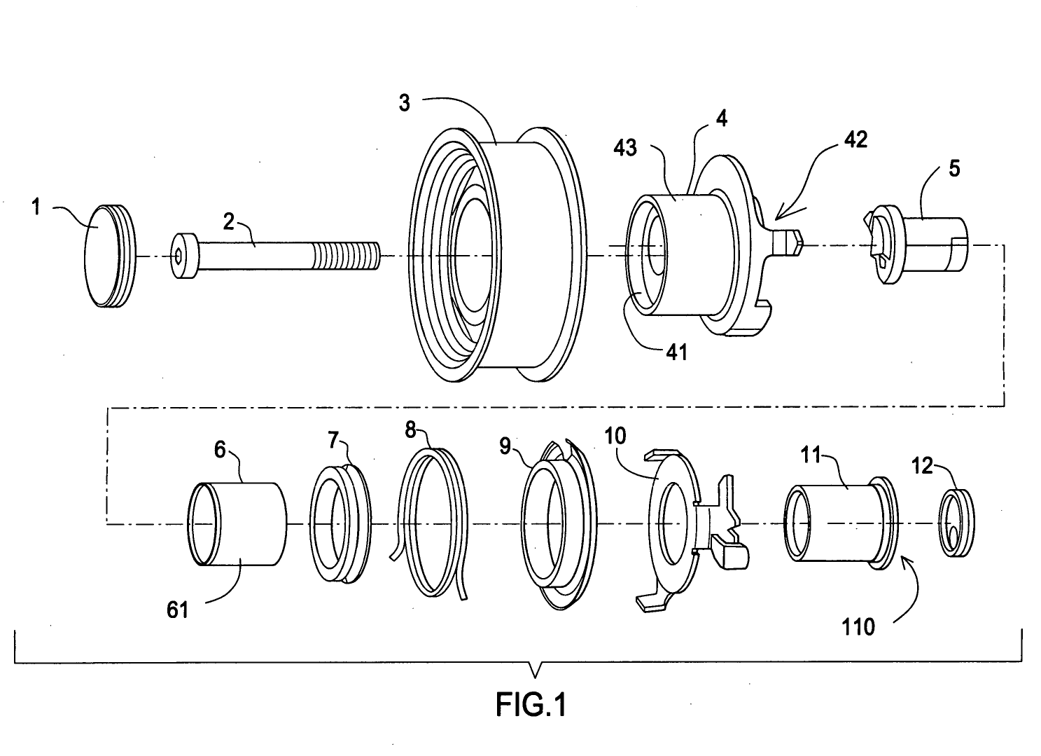

FIG. 1 is an exploded view of the tensioner. End cover 1 is engaged with pivot arm 4. End cover 1 is a static seal that is one of three seals used to seal bushing 6. End cover 1 is one of the two seals used to close the pivot arm 4 from the surrounding oil in an operating environment. Cover 1 prevents a fluid such as oil from contacting bushing 6. Contamination of bushing 6 by oil, or other fluids such as water, or debris will adversely affect operation of the tensioner, namely, oil will lubricate the surface of the bushing effectively reducing or eliminating frictional damping of the pivot arm movement.

End cover 1 is also the final component to be installed during belt installation, since it covers the adjuster 5 that is used to set a predetermined belt tension.

Other seals used to protect bushing 6 are end cover 12 and seal 7. End cover 12 is a static seal that closes the sleeve bore 110 to prevent oil from contacting and contaminating bushing 6. End cover 12 incorporates a secondary seal 120 that engages fastener 2 as it passes through the seal. Secondary seal 120 creates a static seal between end cover 12 and a mounting surface, such as an engine mounting surface.

V-ring seal 7 is a dynamic seal that seals between arm 4 and base 10. Seal 7 comprises a dynamic v-ring seal (VR) known in the art. V-ring seal 7 may comprise any of known styles VR1, VR2, VR3, VR4 or VR5. Seal 7 allows the arm 4 to pivot freely about sleeve 11 and bushing 6 while creating a seal that prevents oil from contacting and contaminating bushing 6.

Bushing 6 not only allows the arm 4 to smoothly pivot about sleeve 11 it also creates friction damping to prevent excessive tensioner motion of arm 4 that is induced by an engine's angular vibration. Hence, there is a coefficient of friction between the bushing and the pivot arm 4 in the range of approximately 01 to 0.5. Once can see that contamination of the bushing by oil would reduce or eliminate the frictional characteristic.

Fastener 2 is used to mount the tensioner to an engine mounting surface. Fastener 2 also locks the adjuster 5 in place after a belt is installed. Fastener 2 may comprise a bolt or other fastener known in the art.

Spring guide 9 is used to contain the spring 8. Spring guide 9 is engaged with an outer surface of arm 4.

Pulley 3 is journalled to arm 4 by a bearing 30. Pulley 3 directly engages a belt to provide belt tension. Bearing 30 may comprise a ball bearing as shown, but may also comprise a needle bearing or other suitable bearing known in the art.

Arm 4 is connected to pulley 3 and is pushed against the belt by spring 8. In this embodiment spring 8 comprises a torsion spring. Spring 8 is also connected to base 10. Base 10 is fixed to the engine using fastener 2. The torque from spring 8 and the effective arm length from arm 4 create the belt tension or load.

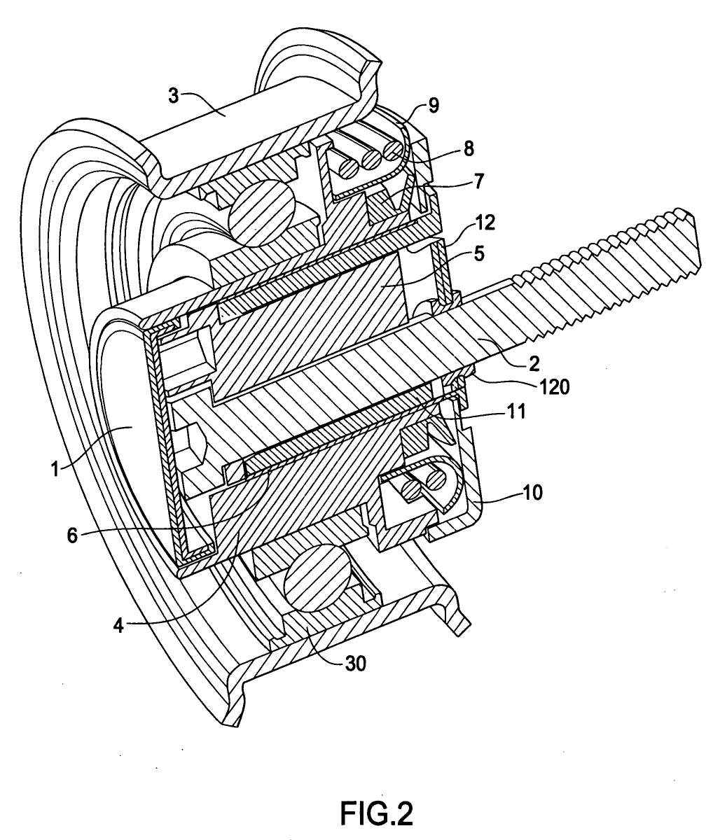

FIG. 2 is a cross-sectional view of the tensioner. Adjuster 5 is pivotally engaged with fastener 2. Sleeve 11 is engaged with adjuster 5. Bushing 6 is engaged with an outer surface of sleeve 11. Arm 4 is pivotally engaged with an outer surface of bushing 6. The frictional damping is developed as a result of the relative movement between the contacting surfaces of the arm 4 and the bushing 6, namely inner surface 42 and outer surface 61.

An inner race of bearing 30 is engaged with an outer surface 43 of arm 4. Pulley 3 is engaged with an outer race of bearing 30.

During installation adjuster is turned in order to properly orient arm 4 and thereby the spring load with respect to a belt. Once adjuster 5 is in proper position, fastener 2 is torqued down in order to immovably secure adjuster 5, bushing 6 and base 10 to a mounting surface. Once fastener 2 is properly torqued end cover 1 is press fit into the receiving end 41 of arm 4.

Arm 4 pivots about bushing 6 during operation of the tensioner. Seal 7 prevents fluid from contacted bushing 6. Seal 7 is engaged with arm 4 and sealingly engages base 10. Spring 8 is engaged between base 10 and arm 4.

Seal 12 is engaged between bushing 6 and seal 120. Seal 120 is engaged between seal 12 and fastener 2. Cover 1 and seals 12 and 120 prevent a fluid from entering between the pivot arm 4 and the base 10, thereby preventing disruption of the pivotal movement of pivot arm 4.

Although a form of the invention has been described herein, it will be obvious to those skilled in the art that variations may be made in the construction and relation of parts without departing from the spirit and scope of the invention described herein.

We claim:

1. A sealed tensioner comprising:
a base;
an arm pivotally engaged with the base;
a pulley journalled to the arm;
a torsion spring engaged with the base and the arm;
a bushing operationally disposed between the base and the arm, the arm being pivotally engaged with the bushing;
a first seal engaged with the arm for preventing a fluid from contacting the bushing; and
a second seal engaged with the base for preventing a fluid from contacting the bushing.

2. The tensioner as in claim 1 further comprising:
a fastener for fixing the tensioner to a mounting surface; and
a seal engaged between the base and the fastener for preventing a fluid from contacting the bushing.

3. The tensioner as in claim 1 further comprising an adjusting member for adjusting an arm position.

4. The tensioner as in claim 1, wherein the bushing damps an arm movement.

5. A tensioner comprising:
a base;
a pivot arm pivotally engaged with the base by a frictional surface;
a spring engaged between the pivot arm and the base; and
a seal for preventing a fluid from contacting the frictional surface.
